(19) United States
(12) Patent Application Publication
(10) Pub. No.: US 2005/0023792 A1
(43) Pub. Date: Feb. 3, 2005

(54) Lateral leaf spring with inboard air spring trailer suspension

(76) Inventors: Steven R. Miller, Clarkston, MI (US); James W. Grant, Royal Oak, MI (US); Gregory D. Pavuk, Royal Oak, MI (US); Kenneth G. Lang, Davison, MI (US); Rod Ehrlich, Monticello, IN (US); Francis Steven Smidler, Lafayette, IN (US); Andrzej Wylezinski, Lafayette, IN (US)

Correspondence Address: CARLSON, GASKEY & OLDS, P.C., 400 WEST MAPLE ROAD, SUITE 350, BIRMINGHAM, MI, 48009, US

(21) Appl. No.: 10/632,546

(22) Filed: Aug. 1, 2003

(51) Int. Cl. B60G 1/00

(52) U.S. Cl. 280/124.163

(57) ABSTRACT

A vehicle suspension system is provided that includes a frame and pair of laterally spaced apart upper control arms pivotally supported by the frame at pivotal connections. A knuckle is connected to each of the upper control arms. A leaf spring is connected to the lower portion of the knuckles at pivotal connections and serves as the lower control arms. The upper control arms extend away from the knuckles, and air springs are arranged between the upper control arms and the frame. A pressurized air system is connected to the air springs to control the air springs for providing desired ride characteristics.

### BACKGROUND OF THE INVENTION

This invention relates to a suspension system for commercial vehicles, and more particularly, the invention relates to a mechanical spring arrangement for use with air springs preferably in commercial trailer applications.

The trailer industry has historically employed mechanical style steel leaf spring suspensions that have the advantage of low maintenance, low initial investment costs, and good loading dock performance. The mechanical suspension has good dock performance because vehicle displacement is relatively small between unloaded and loaded conditions. Furthermore, the suspension provides a stable trailer deck with minimal bouncing during loading and unloading. The shortcoming of the mechanical style suspension is that the ride quality is harsh compared to that of an air spring suspension especially during the unloaded or lightly loaded conditions.

One mechanical leaf spring arrangement use in passenger car applications is shown in FIG. 1 in which the spring is arranged laterally. The system 10 includes a frame 12 that may be constructed from one or more structural members and/or brackets. Upper control arms 14 are pivotally supported by first pivotal connections 16 on the frame 12. Knuckles 18 are supported by a connection 20 on an end of the upper control arm 14. The knuckle 18 includes a spindle 22 for rotationally supporting a wheel end. Lower control arms 24 are spaced apart from the upper control arms 14. The lower control arms 24 are connected to the frame 12 by connections 26. A second pivotal connection 28 on the lower control arm 24 supports the lower portion of the knuckle 18. A lateral leaf spring 30 is arranged between the upper 14 and lower 24 control arms. The spring 30 has opposing ends 32 that are connected to portions of the lower control arms 24 by links 34. Rubber pivots 35 are arranged between the frame 12 and the lateral leaf springs 30 to dampen the movement of the suspension system 10. However, the configuration shown in FIG. 1 still may provide harsh ride quality.

Due to the shortcomings of mechanical leaf springs described above, air springs have gained a significant portion of the trailer suspension market in recent years. Air suspensions have good ride quality regardless of load. The drawbacks of the air suspension are that it typically has higher maintenance, higher initial investment costs, and inferior dock performance without additional devices. Air springs also are typically heavier and have poor axle-to-axle load equalization as compared to that of a mechanical suspension. Most air suspensions require additional devices to limit suspension travel so that the trailer deck height drop is minimized and the trailer is stable for loading and unloading. Therefore, what is needed is a trailer suspension that provides the benefits of both mechanical suspensions and air suspensions. Specifically, what is needed is a suspension having a ride quality similar to that of an air suspension with the low maintenance, superior load equalization, and good dock performance of a mechanical suspension.

### SUMMARY OF THE INVENTION AND ADVANTAGES

The present invention provides a vehicle suspension system including a frame. A pair of laterally spaced apart upper control arms are pivotally supported by the frame at pivotal connections. A knuckle is connected to each of the upper control arms. A leaf spring is connected to the lower portion of the knuckles at pivotal connections and serves as the lower control arms. The upper control arms extend away from the knuckles, and air springs are arranged between the upper control arms and the frame. A pressurized air system is connected to the air springs to control the air springs for providing desired ride characteristics.

Accordingly, the above embodiments of the present invention provide the benefits of mechanical suspension by utilizing the lateral leaf spring while obtaining the benefits of an air suspension by utilizing air springs with the lateral leaf spring.

### BRIEF DESCRIPTION OF THE DRAWINGS

Other advantages of the present invention can be understood by reference to the following detailed description when considered in connection with the accompanying drawings wherein:

FIG. 1 is a schematic view of a prior art mechanical suspension;

FIG. 2 is a schematic view of the present invention mechanical/air suspension;

FIG. 3A is a schematic view of the present invention suspension undergoing jounce;

FIG. 3B is a schematic view of the present invention suspension undergoing roll; and

FIG. 3C is a schematic view of the present invention receiving an input from the roadway on one side of the suspension

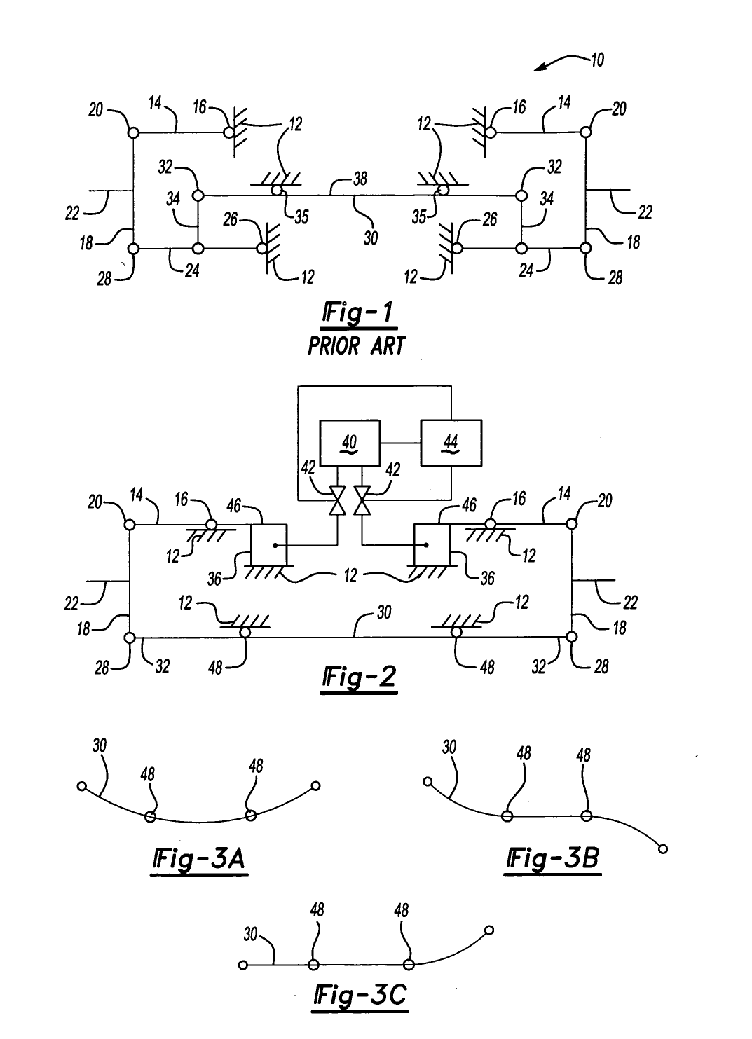

### DETAILED DESCRIPTION OF THE PREFERRED EMBODIMENT

A vehicle suspension system 10 is shown schematically in FIG. 2. The system 10 includes a frame 12 that may be constructed from one or more structural members and/or brackets. Upper control arms 14 are pivotally supported by first pivotal connections 16 on the frame 12. Knuckles 18 are supported by a connection 20 on an end of the upper control arm 14. The knuckle 18 includes a spindle 22 for rotationally supporting a wheel end. A lateral leaf spring 30 is arranged between the knuckles 18, and the opposing ends 32 are connected to the knuckles at second pivotal connections 28. The lateral leaf spring may replace the lower control arms and may be constructed from a suitable composite. The lateral leaf spring 30 may be pivotally connected to the frame 12 by connections 48. As is known in the art, the knuckles 18 move vertically in response to an input from the roadway. The knuckles 18 rotate about the axis defined by the connections 20 and 28 in response to a steering input.

The system 10 includes upper control arms 14 that have portions 46 extending from the first pivotal connection 16 away from the connection 20. Air springs 36 may be arranged between the portions 46 and the frame 12. It is to be understood that the air springs 36 may also be arranged in other locations. For example, the air springs 36 may be arranged between the leaf spring 30 and the frame 12. The air springs 36 receive air from a pressurized air source 40. The pressure to the air springs 36 is metered by valves 42 that are controlled by a controller 44 that may also be connected to the pressurized air source 40. The pressurized air system may also provide load leveling and other desired suspension control features. In the preferred embodiment, each air spring 36 has its own independently control valve 42 so that different pressures may be maintained in the air springs 36 for maintaining lateral stability such as during dock loading conditions. Devices used for detecting vehicle stability during travel or loading conditions may also be connected to the controller 44, but are not shown.

A jounced condition is shown in FIG. 3A. The opposing ends 32 of the leaf spring 30 deflect upward, and the air springs 30 dampen the movement of the ends of the leaf spring 30 through the upper control arms 14. A roll condition is shown in FIG. 3B. One end 32 is deflected upward while another end 32 is deflected downward during a turning maneuver. Since independent air springs 36 are used, the ends of leaf spring 30 may be damped independently through the upper control arms 14. The lateral leaf spring 30 may receive an input from the vehicle roadway on only one end, as shown in FIG. 3C. One of the air springs 36 may provide independent damping to the deflected end of the leaf spring 30 through the upper control arms 14.

The invention has been described in an illustrative manner, and it is to be understood that the terminology that has been used is intended to be in the nature of words of description rather than of limitation. Obviously, many modifications and variations of the present invention are possible in light of the above teachings. It is, therefore, to be understood that within the scope of the appended claims the invention may be practiced otherwise than as specifically described.

1. A vehicle suspension system comprising:
a frame;
a pair of laterally spaced apart upper control arms pivotally supported by said frame at first pivotal connections;
a knuckle connected to each of said upper control arms;
a lateral leaf spring interconnected between lower portions of said knuckles; and
laterally spaced apart air springs arranged between said frame and one of said upper control arms and said lateral leaf spring.

2. The system according to claim 1, wherein said air springs are arranged between said frame and said upper control arms.

3. The system according to claim 2, wherein said upper control arms extend from said first pivotal connections to a portions opposite said knuckles, said air springs arranged between said portions and said frame.

4. The system according to claim 2, wherein opposing ends of said lateral leaf spring supports said lower portions of said knuckles at second pivotal connections.

5. The system according to claim 1, wherein a pressurized air source is connected to said air springs providing a desired quantity of pressurized air to said air springs with a controller connected to said air source determining said desired quantity.

6. The system according to claim 5, wherein said pressurized air source includes valves actuated by said controller to provide said desired quantity.

7. The system according to claim 6, wherein said valve is associated with each of said air springs with said valves being independently actuatable in response to commands from said controller.
